(19) United States
(12) Patent Application Publication
(10) Pub. No.: US 2014/0350963 A1
(43) Pub. Date: Nov. 27, 2014

(54) DENTAL PRACTICE MANAGEMENT SYSTEM AND METHOD

(71) Applicant: Carestream Health, Inc., Rochester, NY (US)

(72) Inventors: Kristopher S. Kinlen, Marietta, GA (US); Craig M. Sentell, Alpharette, GA (US); Jeffrey B. Thompson, Marietta, GA (US); John T. Wildharber, Kennesaw, GA (US); Kevin P. Moloney, Peachtree, GA (US); Christopher Tyson Edwards, Decatur, GA (US); Christopher Octa, Atlanta, GA (US); Jerry Dickens, Atlanta, GA (US); Paul Bisceglia, Hertfordshire (GB)

(21) Appl. No.: 14/282,206

(22) Filed: May 20, 2014

Related U.S. Application Data
(60) Provisional application No. 61/825,565, filed on May 21, 2013.
(60) Provisional application No. 61/825,582, filed on May 21, 2013.
(60) Provisional application No. 61/825,591, filed on May 21, 2013.

(51) Int. Cl. G06F 19/00

(52) U.S. Cl. CPC G06F 19/327; G06F 19/322
USPC 705/3; 705/2

(57) ABSTRACT

A dental management practice system and method for a dental office.

### CROSS REFERENCE TO RELATED APPLICATIONS

This application claims the benefit of U.S. Provisional application U.S. Ser. No. 61/825,565, provisionally filed on May 21, 2013, entitled “DENTAL PRACTICE MANAGEMENT SYSTEM”, in the names of Kinlen et al, which is incorporated herein by reference in its entirety.

This application claims the benefit of U.S. Provisional application U.S. Ser. No. 61/825,582, provisionally filed on May 21, 2013, entitled “DENTAL PRACTICE MANAGEMENT SYSTEM—RECORD PERIODONTIC STATE”, in the names of Kinlen et al, which is incorporated herein by reference in its entirety.

This application claims the benefit of U.S. Provisional application U.S. Ser. No. 61/825,591, provisionally filed on May 21, 2013, entitled “DENTAL PRACTICE MANAGEMENT SYSTEM—CLINICAL FRAMEWORK”, in the names of Kinlen et al, which is incorporated herein by reference in its entirety.

### FIELD OF THE INVENTION

The invention relates generally to the field of software, and in particular to software for healthcare management applications. More specifically, the invention relates to a dental practice management system and method.

### BACKGROUND

Although the tools of the healthcare trade have changed and evolved over the years, the basic practice of medicine or dentistry has always consisted of diagnosing the condition of a patient, charting or documenting the condition, planning the course of treatment, constructing and presenting the treatment plan to the patient, selling or explaining the treatment plan to the patient, and then performing the subsequent work. Healthcare professionals go through rigorous formal education on the medical and clinical aspects above: diagnosing, charting, planning treatment, and performing treatment. However, the construction, presentation, and selling of proposed treatments are not the major focus of a healthcare professional's education.

With the advances in technology and development of computers, the practice of healthcare is evolving to take advantage of new tools and technological advances that improve productivity and generate new revenue opportunities for the healthcare professional. In the case of dentistry, most dental offices today use practice and clinical management software to automate the daily tasks of running a dental office. Although information and functionality vary among the different systems on the market, most track critical information such as guarantors, patients, insurance information, medical history, prescriptions, billing information, recall information, treatment plans and work performed, full restorative dental charts, periodontal charts, digital x-rays, digital camera images and estimated insurance payments. Practice management software has become one of the computer applications for the dental field. The use of practice management software is also prevalent in other healthcare disciplines.

U.S. Pat. No. 7,756,727 (Greenspan), incorporate herein by reference, describes a system which generates and tracks presentations for a dental patient.

U.S. Pat. No. 8,160,899 (Rhodes) describes a knowledge based electronic clinical record for dentistry.

While such systems may have achieved certain degrees of success in their particular applications, there is a continued need for practice management software.

### SUMMARY

Certain embodiments described herein address the need for practice management software.

These aspects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 shows a general dental office arrangement suitable for use by the practice management system and method of the present invention.

FIG. 2 shows a view of a graphical user interface (GUI) on a display.

FIG. 3A-3B shows a view on a display of a particular patient record.

FIGS. 4-7 show views on a display of the particular patient record of FIG. 3 illustrating an alert feature.

FIGS. 8-12 show views on a display illustrating a notification feature.

FIGS. 13-17 show views on a display illustrating a dental charting feature.

FIGS. 18A-18E show views on a display illustrating financial reporting features.

FIGS. 19A-19B show views on a display illustrating a medical alert feature.

FIGS. 20A-20F show views on a display illustrating detailed information about a patient and their scheduling/appointments.

### DETAILED DESCRIPTION OF EXEMPLARY EMBODIMENTS

The following is a detailed description of the embodiments of the invention, reference being made to the drawings in which the same reference numerals identify the same elements of structure in each of the several figures.

In the following description, a preferred embodiment of the present invention will be described as a software program. Those skilled in the art will recognize that the equivalent of such software may also be constructed in hardware. Because image manipulation algorithms and systems are well known, the present description will be directed in particular to algorithms and systems forming part of, or cooperating more directly with, the method in accordance with the present invention. Other aspects of such algorithms and systems, and hardware and/or software for producing and otherwise processing the image signals involved therewith, not specifically shown or described herein may be selected from such systems, algorithms, components and elements known in the art.

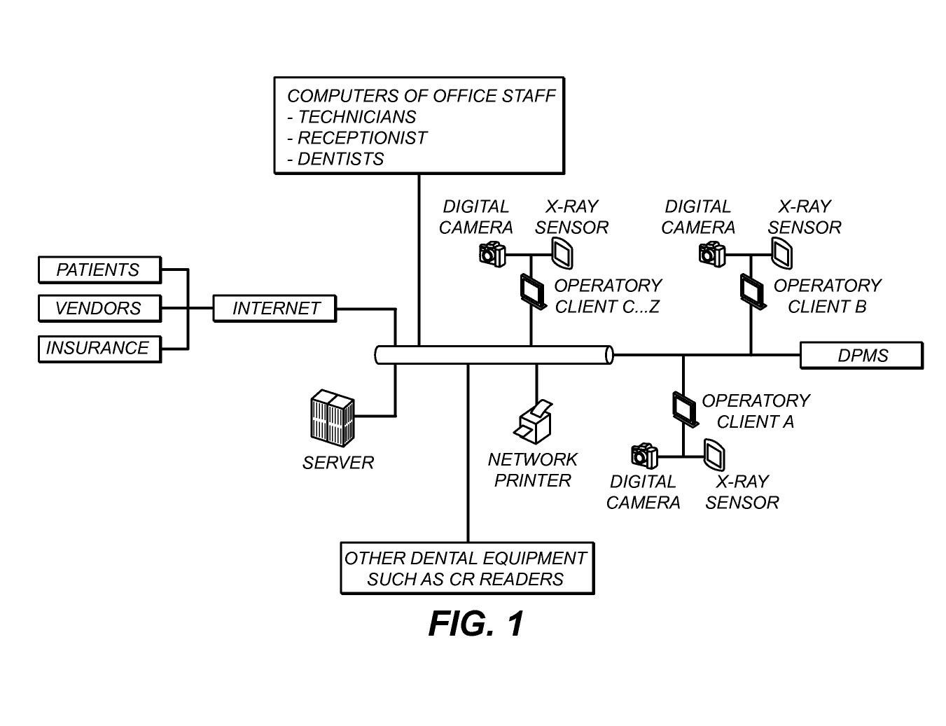

FIG. 1 illustrates a general dental office communications arrangement. A network allows communication between the office staff, patients, the office's dental equipment, and outside entities (e.g., vendors, laboratories, and insurance companies). The dental office may have a plurality of treatment/operatory rooms as well as other equipment (e.g., office computers, displays, a printer, a computed radiography (CR) reader, and analog x-ray processor).

A dental practice management system (DPMS) can control/store/maintain/distribute/display the information between the office staff, patients, the office's dental equipment, and the outside entities. This includes scheduling, charting, treatment planning, insurance management, and storing of patient information and digital images. For example, as described in U.S. Pat. No. 7,756,727 (Greenspan), incorporate herein by reference, the system can generate and track presentations for a dental patient.

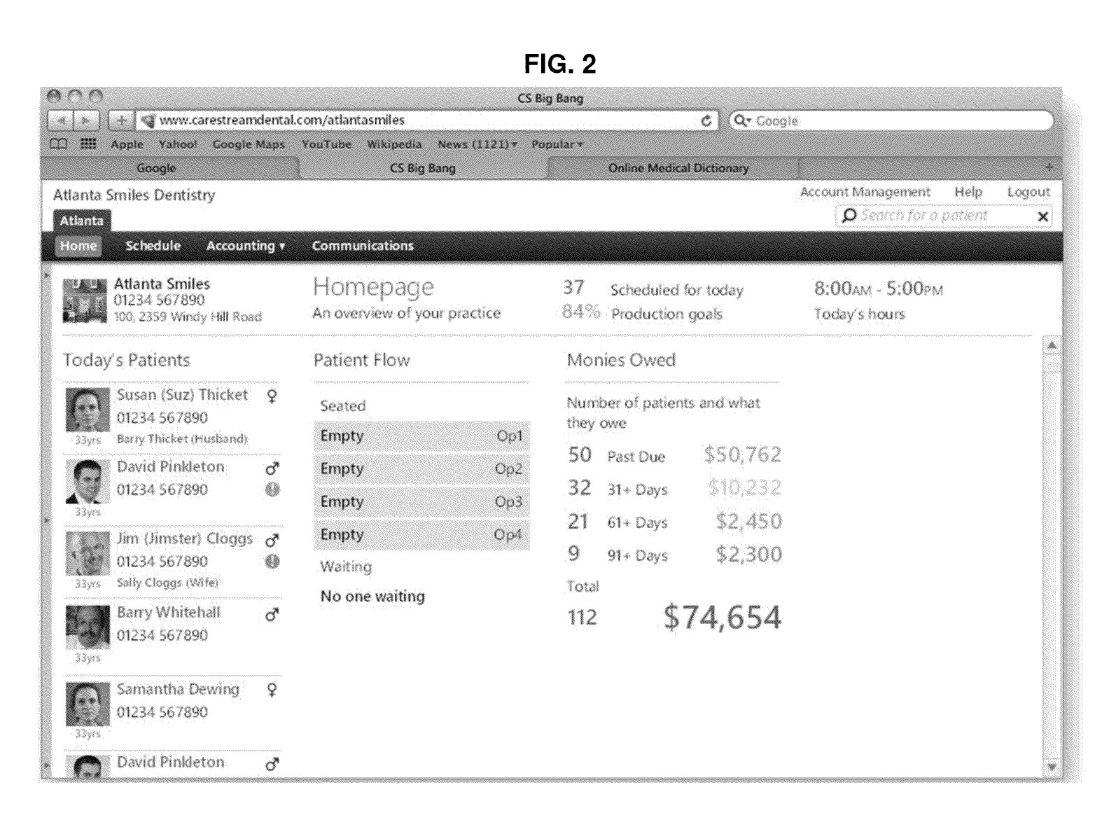

The system provides for the display (e.g., a computer display) of general information about patients. FIG. 2 shows an exemplary screenshot window pane view on a computer display of a graphical user interface (GUI) of one embodiment of the system of the present invention. As illustrated, a listing of the patients visiting the dental office on a particular day is displayed. Each listing provides access to the patient's record in the system.

Also shown in FIG. 2 is an overview of the financial progress/status of the dental practice.

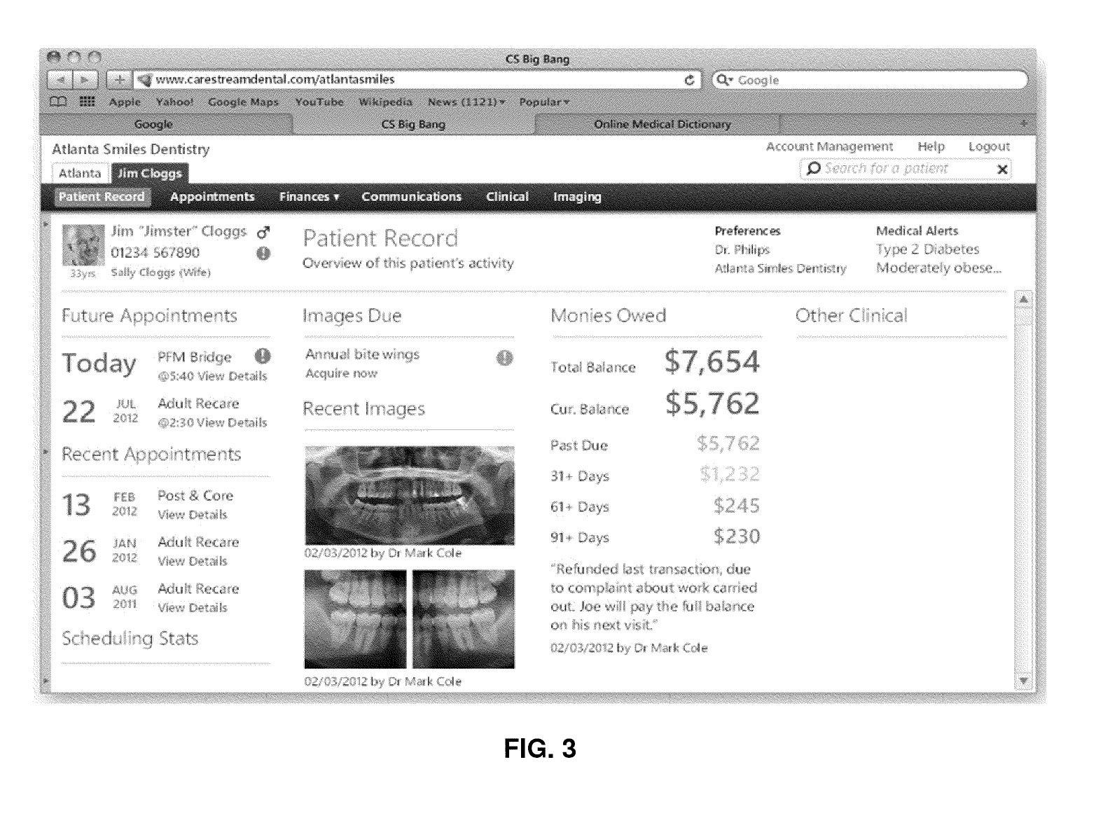

Specific information about each patient is stored in a separate record. FIG. 3 shows an exemplary screenshot window pane view on a display of a graphical user interface (GUI) of one embodiment wherein information about a specific patient is displayed.

Several alert indicators are shown in FIG. 2. A red alert indicator and a yellow alert indicator are illustrated. Each illustrated alert indictor is associated with a particular patient, and provides an alert to the dental office staff regarding an issue requiring attention. The color of the alert indicator indicates the severity of the issue. For example, a red alert indicator indicates a critical issue while a yellow indicator indicates a less severe issue.

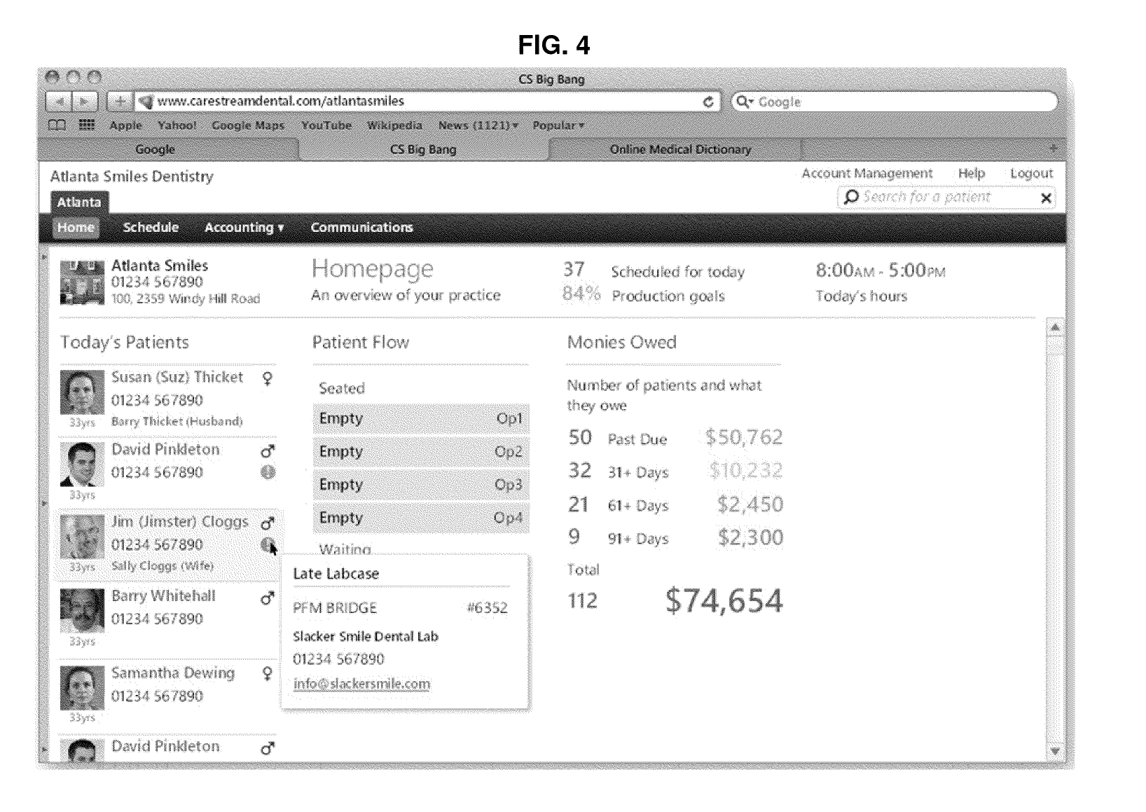

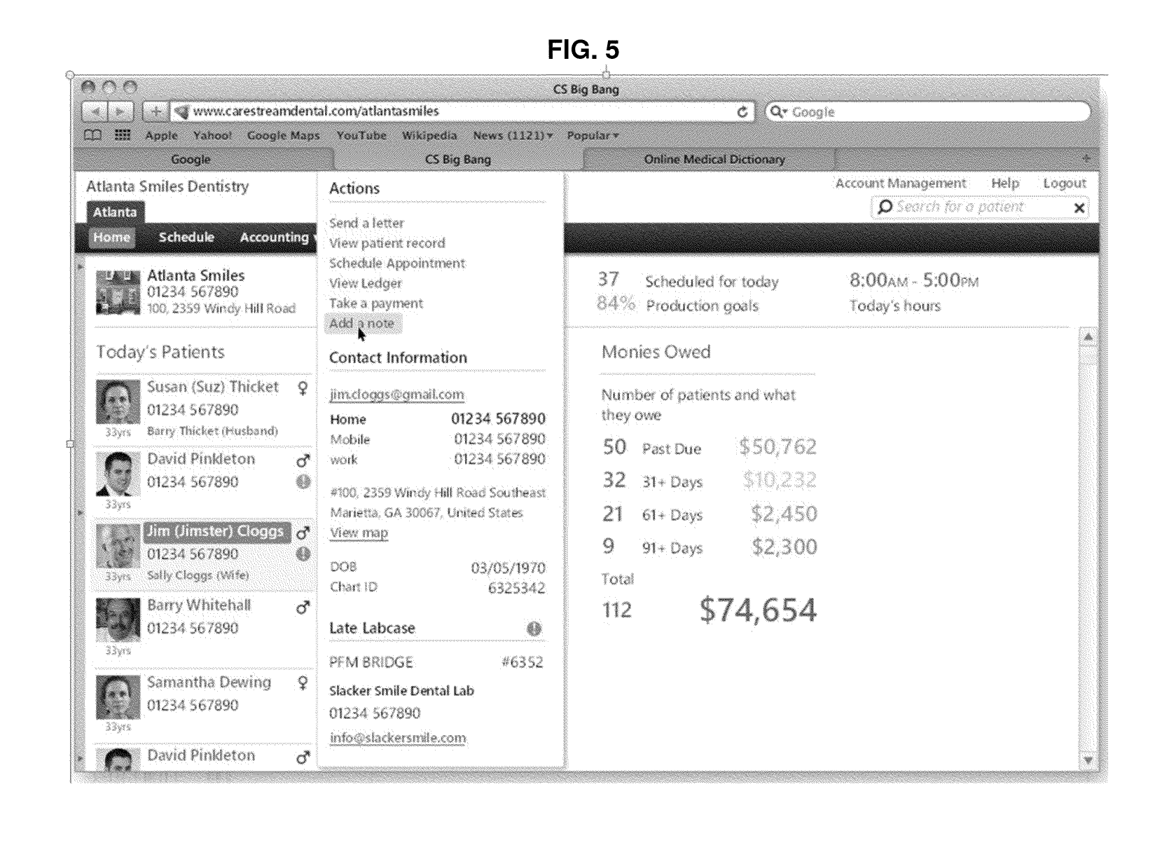

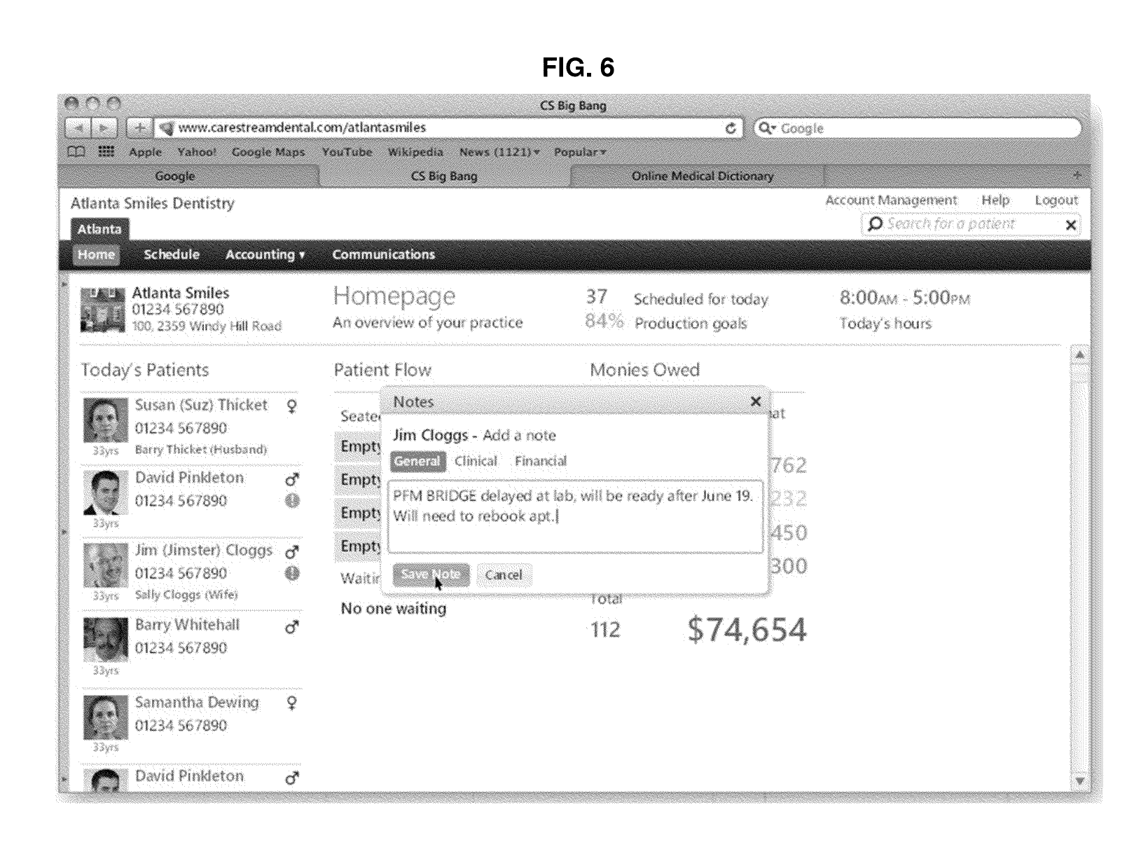

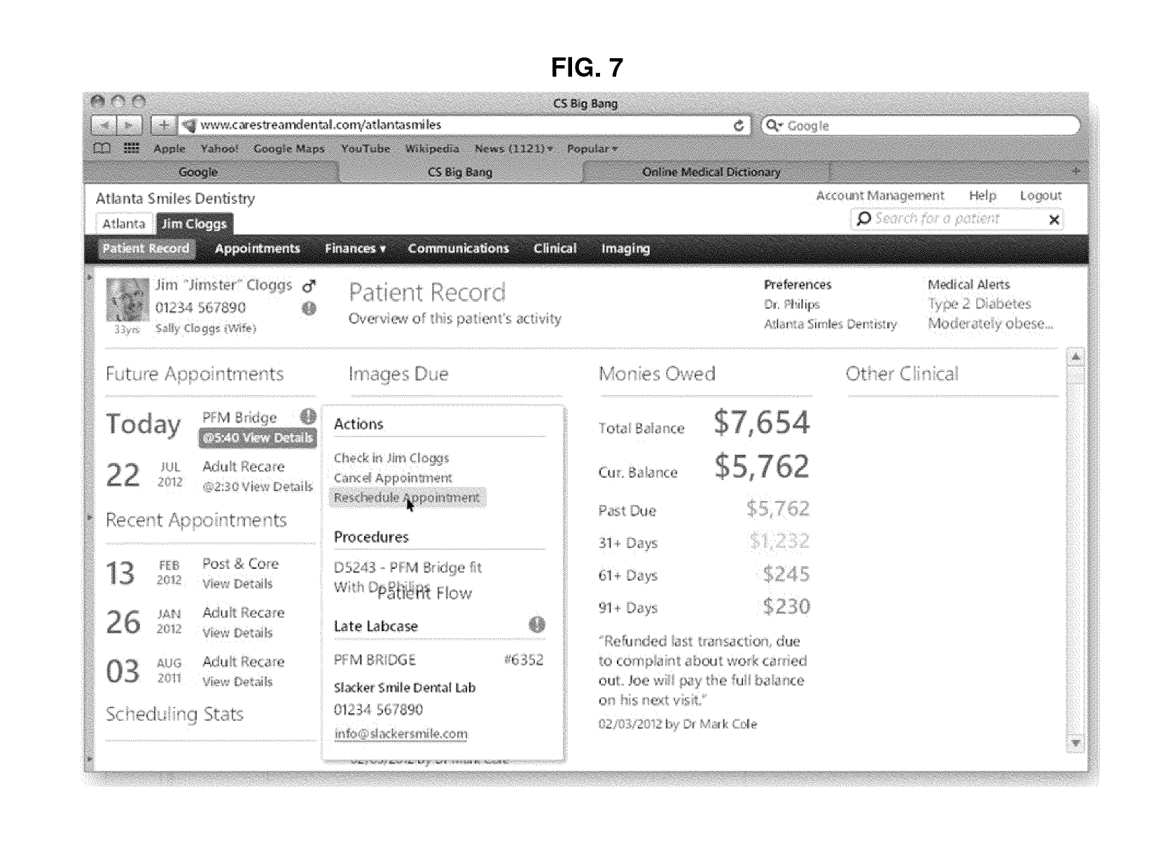

When accessing the individual patient information, the detailed information about the alert is displayed to the office staff. Referring to FIG. 4, the red alert indicated that some required laboratory information has not been received, and this affects the patient's scheduled appointment. Accordingly, as noted in FIGS. 5-7, this issue is noted and resolved by adding/saving a note to the patient record and rescheduling the patient's appointment. In addition, an email and/or text message can be sent to the patient notifying/confirming the rescheduled appointment. A copy of the email/text message can be stored with the patient's record.

As such, the office staff accesses the patient's record in the dental management practice system. Once accessed, the office staff updates the patient's record in response to the alert indicator associated with the patient record, the alert indicator being indicative of an event affecting an appointment scheduled for the patient, for example, missing laboratory results.

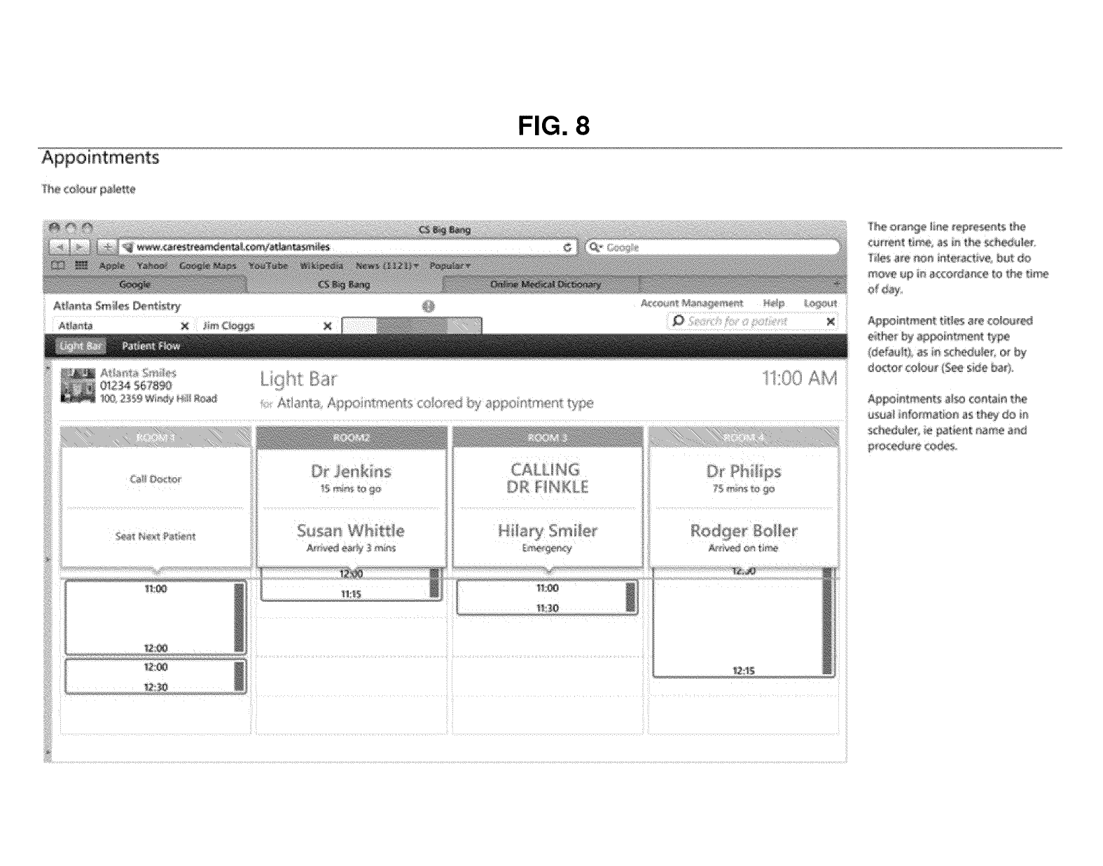

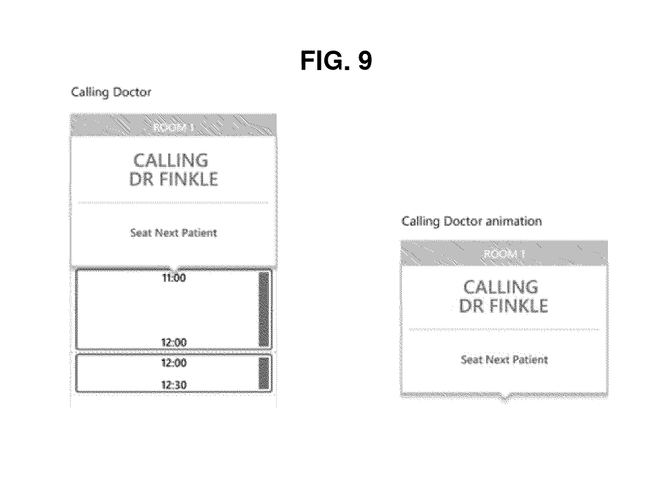

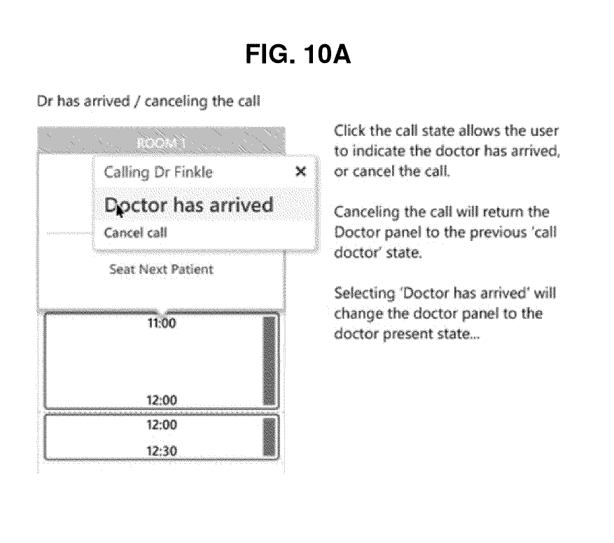

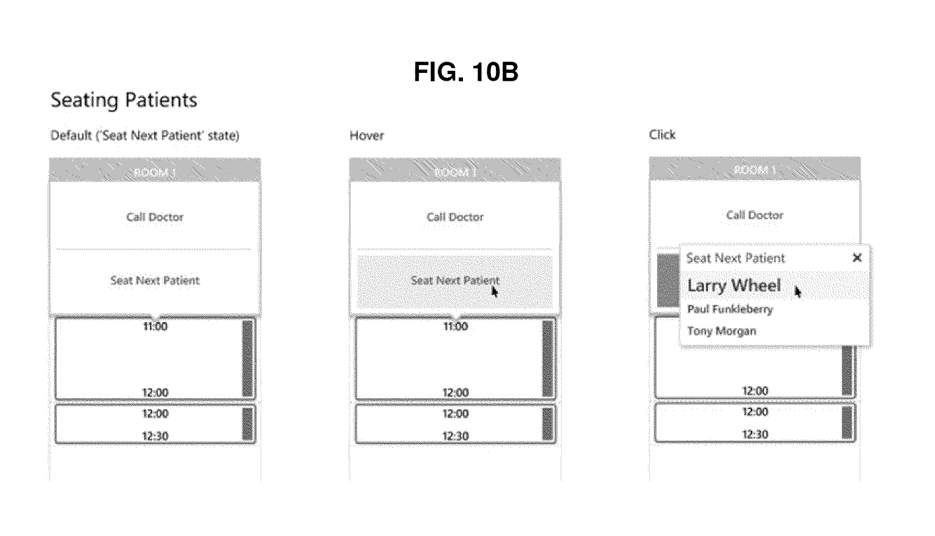

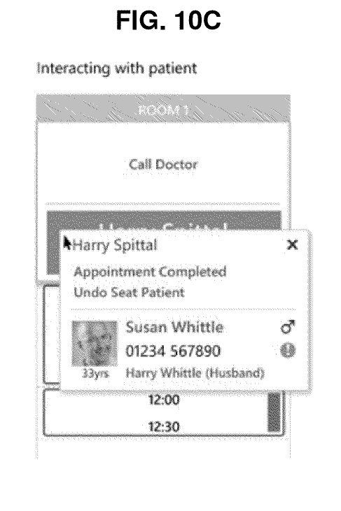

Once the patient has arrived at the office, there is a need to inform the dental professional (such as a technician, hygienist, dentist, or the like) of the arrival of the patient. The dental practice management can be used to inform/notify the dental professional, for example as shown in FIG. 8. As noted in FIG. 9, notification can be immediate static notification, such as a single message sent to the dental professional's computer screen. The notification can be an animation—for example, the border and header color can fill/fade to a particular color. Alternatively, the notification can be audible, such a via a pager or text/telephone message. Referring to FIGS. 10A-10C, once the dental professional has received/acknowledge the notification, the notification can be cancelled.

Colors can be assigned to specific dental professionals. If assigned to specific dental professionals, the location of each dental professional can be tracked using a colored icon in a header bar on a computer display.

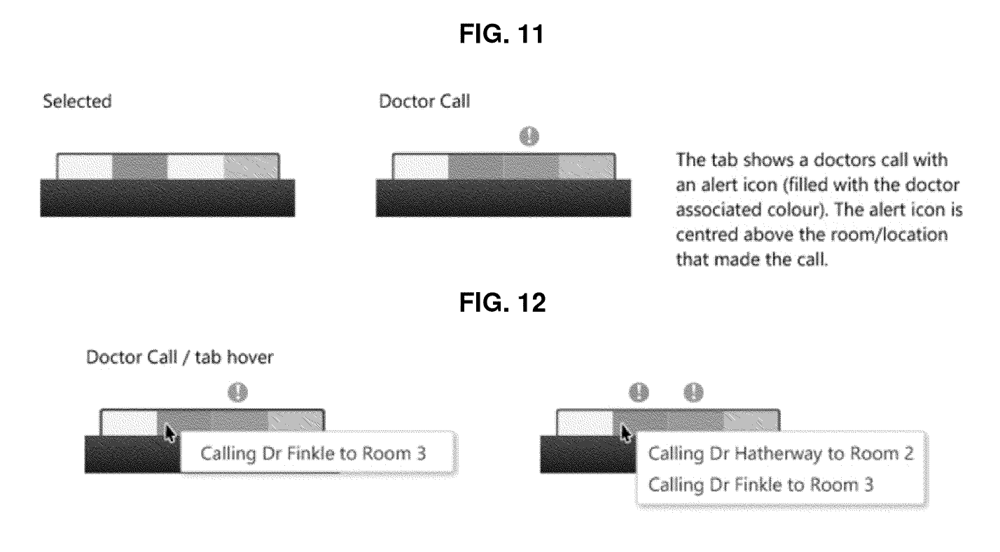

For example, as illustrated in FIG. 8, the header bar includes a Locator with 4 sections/icons, indicating 4 rooms at the dental facility—Rooms 1, 2, 3, and 4. As illustrated, each section of the Locator has a rectangular shape. There is no patient in Room 1, so that section of the Locator is colored as white/clear. The section associated with room 2 shows the particular color associated with Dr Jenkins since Dr Jenkins is in Room 2 with her patient. Similarly, the section associated with Room 4 shows the particular color associated with Dr Philips since Dr Philips is in Room 4 with her patient. There is an alert indicator placed above the section associated with Room 3, colored with the color associated with Dr. Finkle. The alert indicator indicates that Dr. Finkle was not yet in the room with the patient. FIGS. 11-12 illustrates further details and configurations.

In another arrangement, color can be used to indicate the type of exam/treatment/appointment scheduled for the particular treatment room.

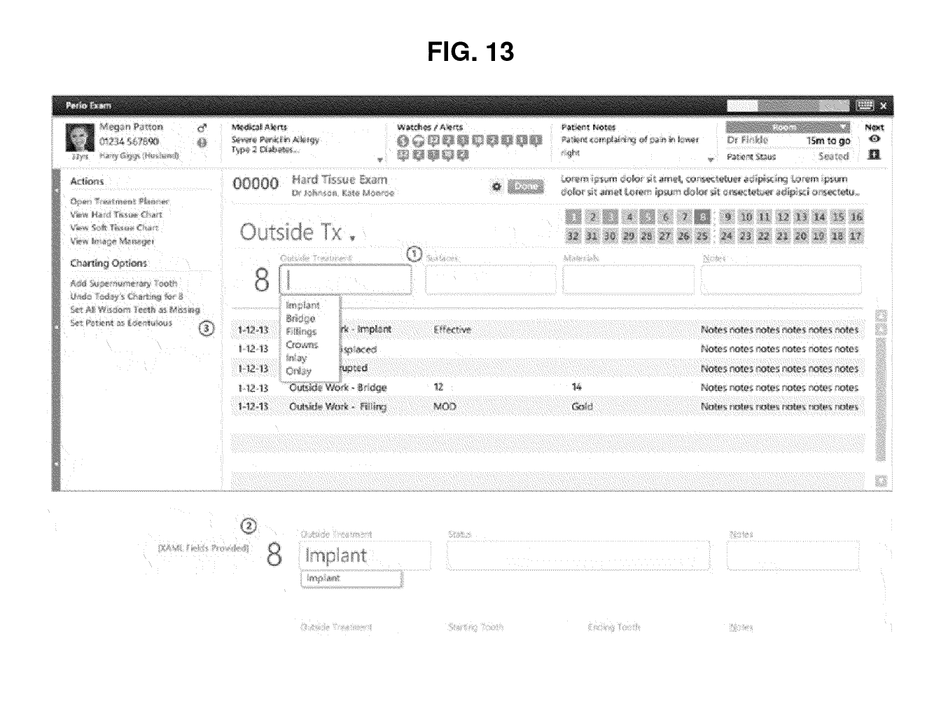

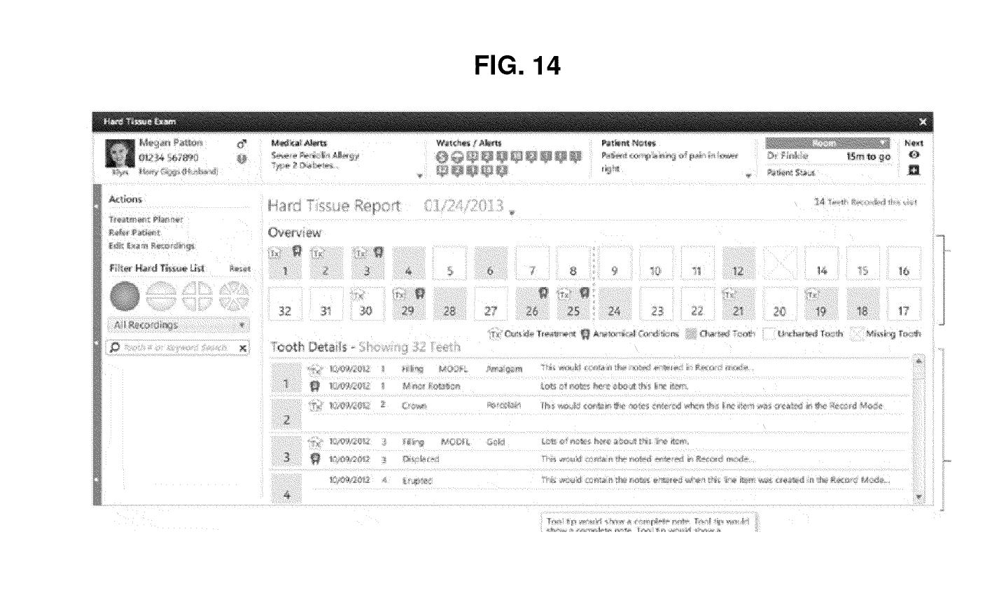

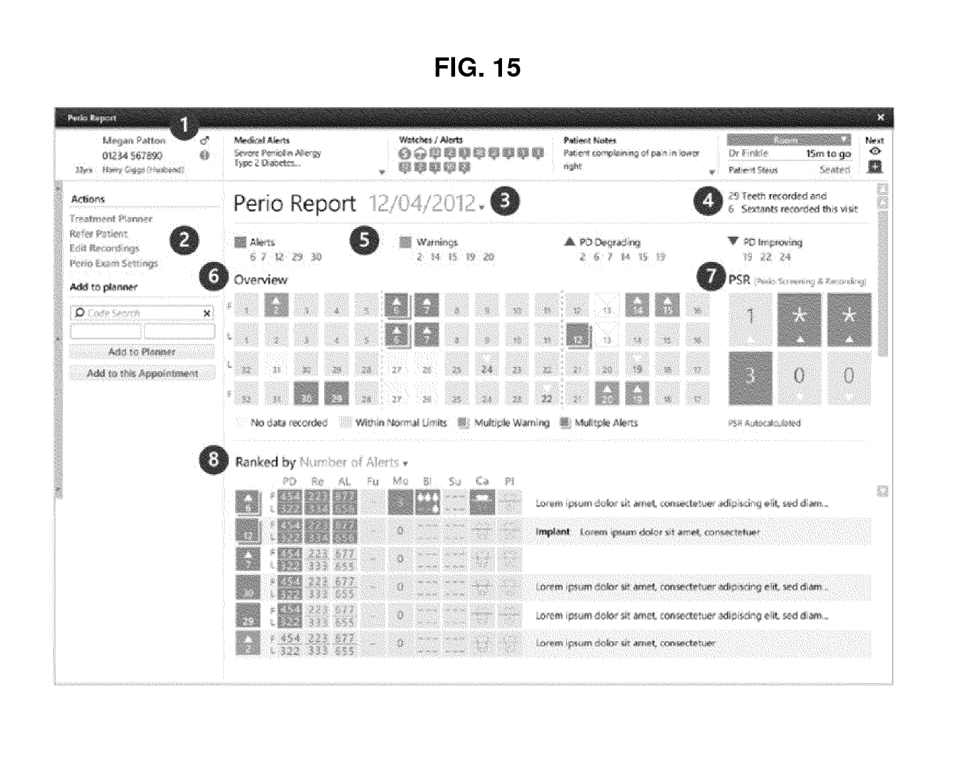

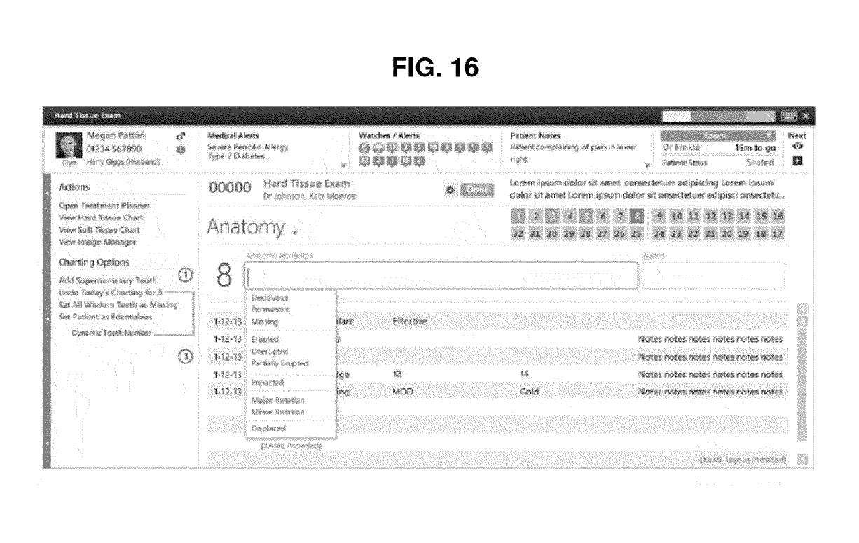

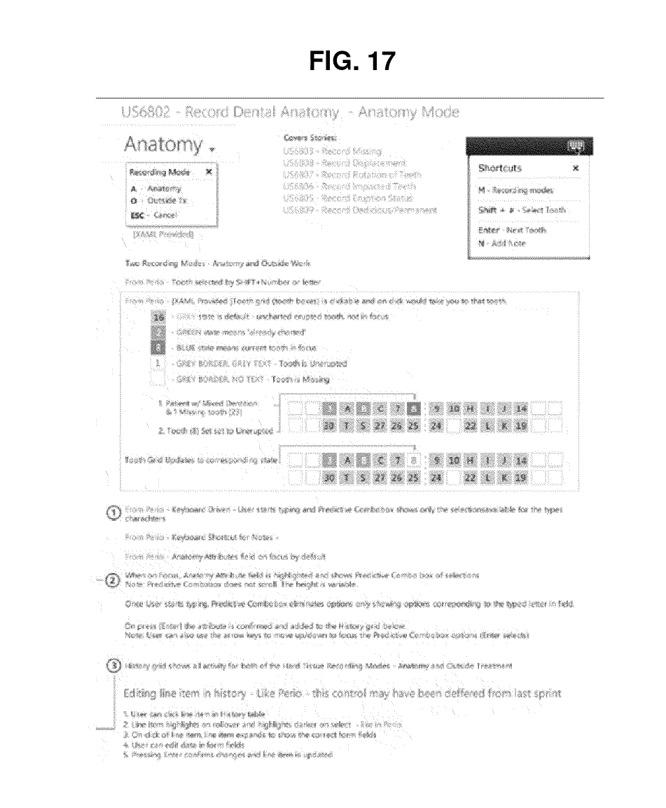

Charting is an important aspect of a dental practice management system since it tracks information about the patient. FIGS. 13-17 show exemplary views on a display of a graphical user interface (GUI) of dental charting of a patient. Icons representative of particular dental aspects can be associated with a specific tooth. One or more icons can be associated with a specific tooth. The icons can be of varying color, shape, size, representation, as shown in FIG. 13 along the top edge of the display. Referring to FIG. 14, the icon for “Outside Treatment” is associated with teeth numbers 1, 2, 3, 29, 30, 25, 21, and 19. Similarly, the icon for “Anatomical Conditions” is associated with teeth numbers 1, 3, 29, 26, and 25. This visual aspect provides a dental professional with a quick visual reference. Detailed information about each tooth can be obtained by selecting the tooth number. In FIG. 15, text, graphical representations, icons, and/or color coding are used to provide a visual state/treatment to the dental professional for focus on particular areas. For example, a upward triangle indicates “PD Degrading” while a downward triangle indicates “PD Improving”. (PD referring to pocket depth.) Other states/treatments which could be noted include recession, mobility, furcation, plaque and calculus. Colors (such as yellow and red) can be used to indicate the severity of a particular aspect. In addition, a ranking of the teeth by severity can be displayed, as shown in FIG. 15.

A chart of the software tissue and hard tissue can be simultaneously displayed.

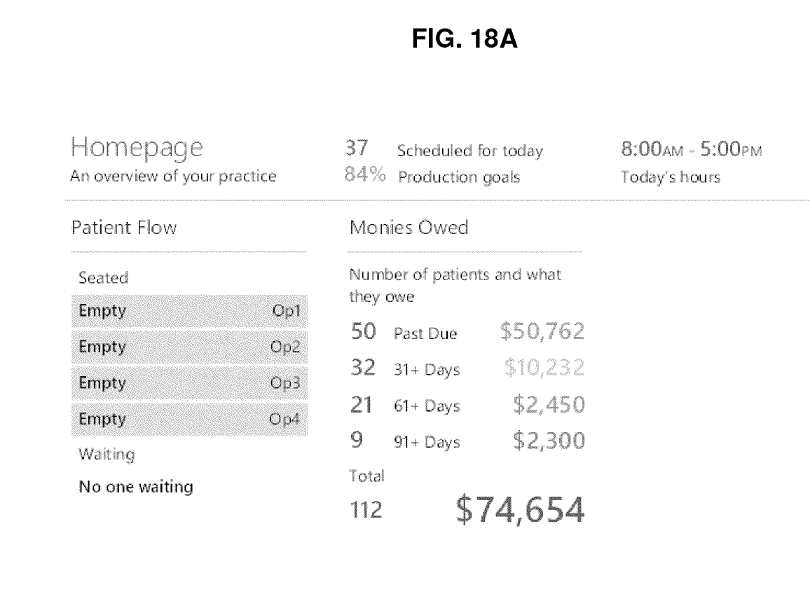

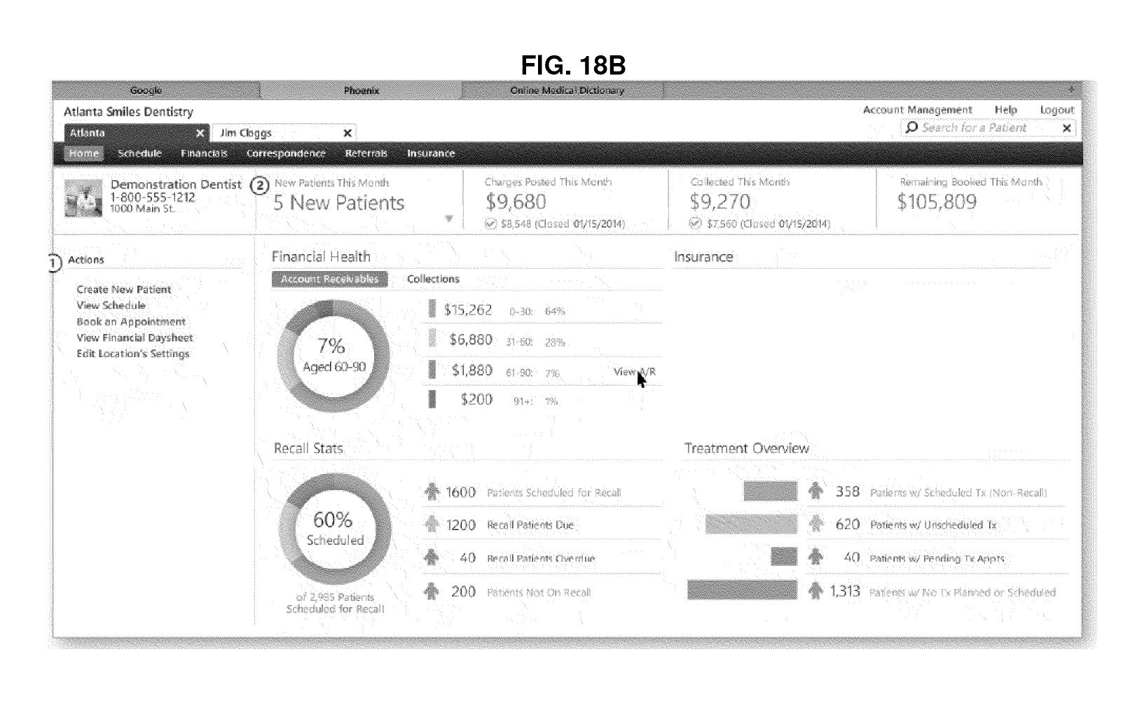

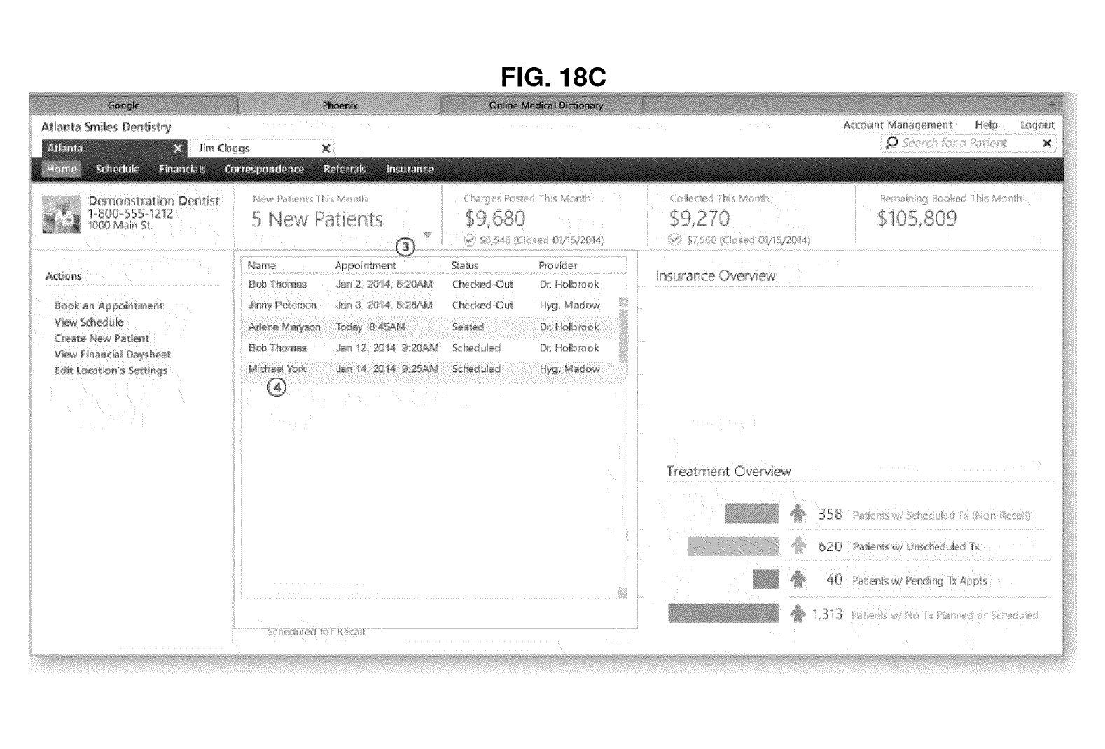

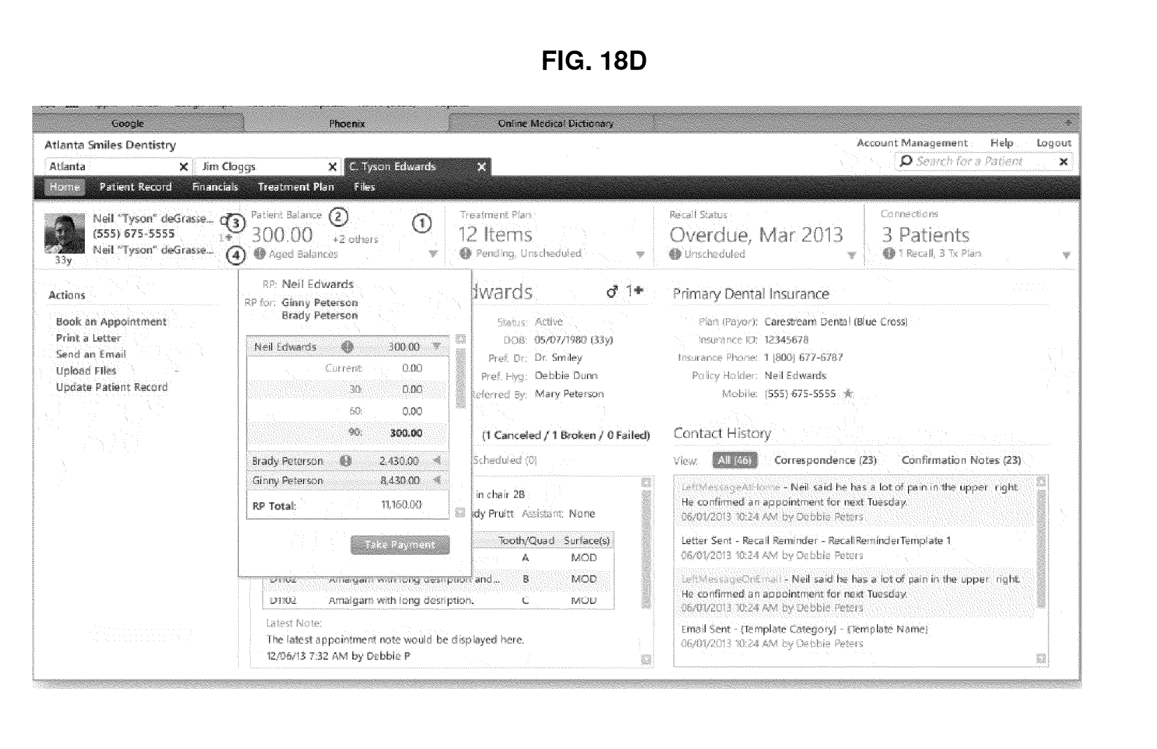

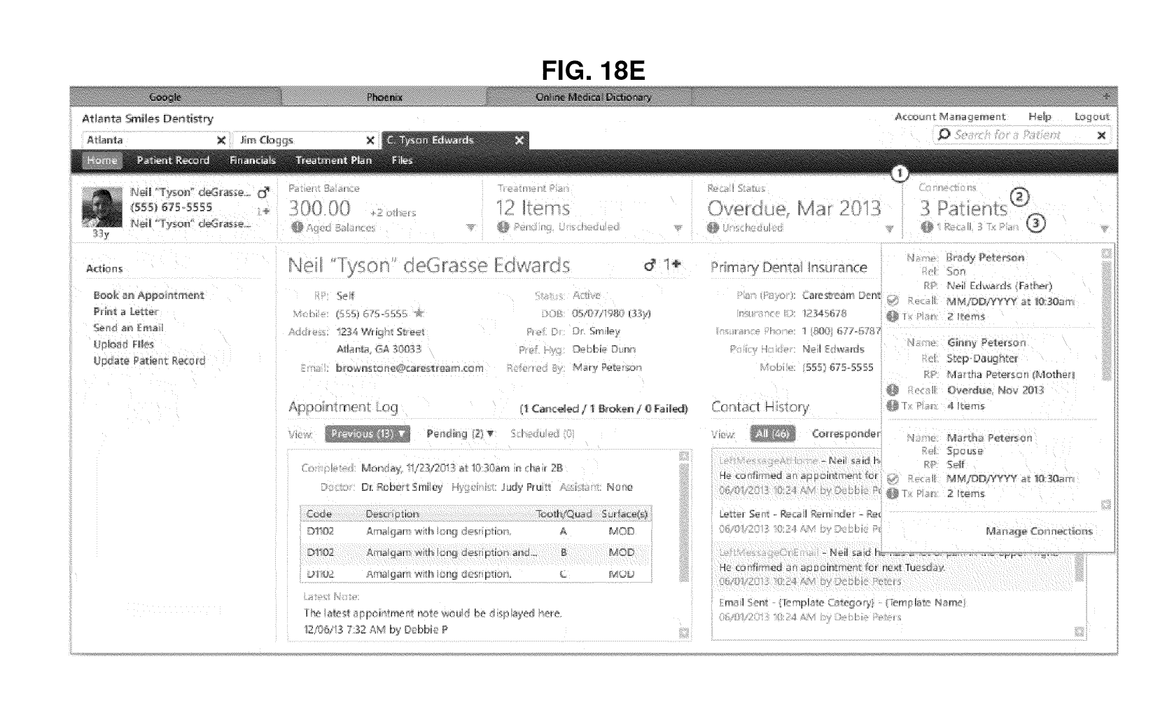

Referring to FIG. 3 and FIGS. 18A-18E, financial reporting can assist the dental office in managing their practice. Accordingly, accounts receivable can be displayed on the main page and/or with each patient record. Notes can be added by the dental office staff for reminders to the patient. Daily production goals and monthly data for the dental practice can be determined and displayed. As noted in FIG. 18E, since more than one family member may be a patient at the dental practice, financial reporting for the entire family can be determined and displayed.

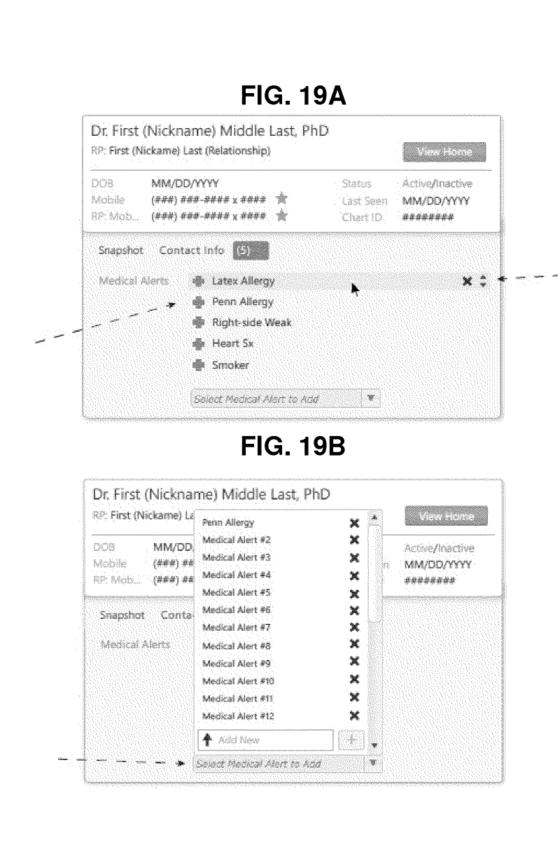

Recording medical information such as patient allergies is important. Accordingly, a medical alert indicator is prominently displayed on each patient record. For example, as shown in FIG. 3 in the upper right-hand corner of the screen display. Referring to FIGS. 19A-19B, upon selecting the medical alert indicator, detailed information is available for viewing and/or updating.

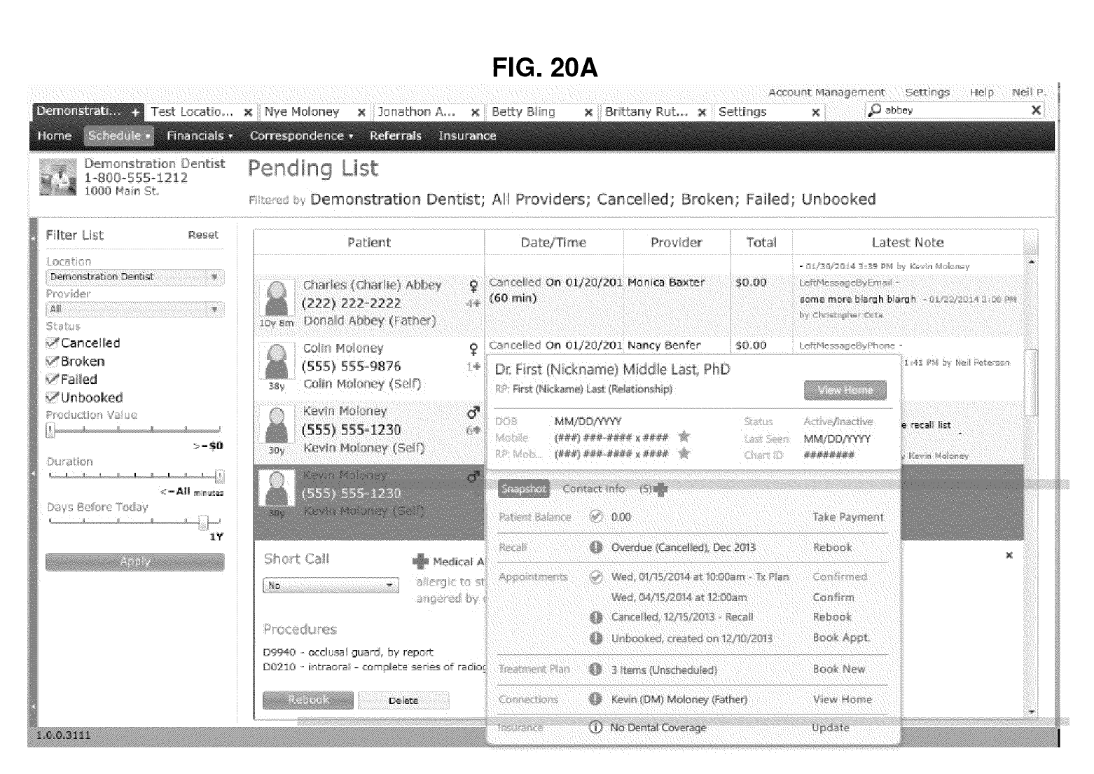

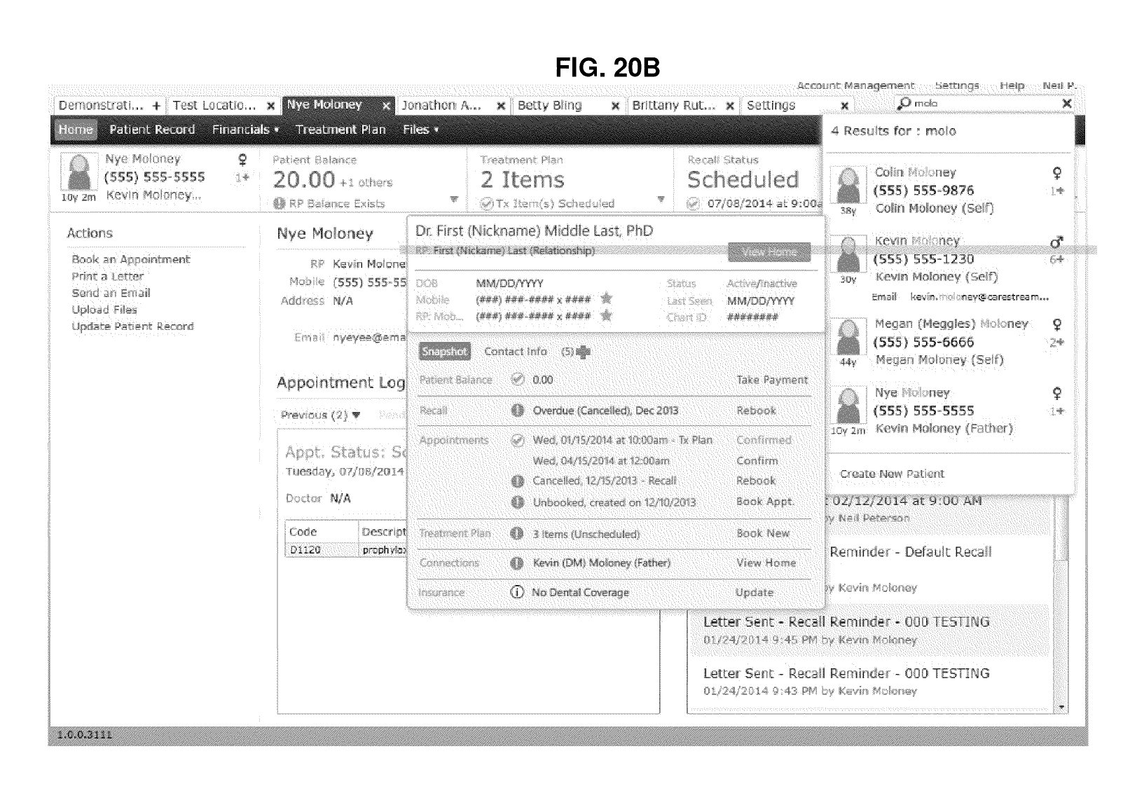

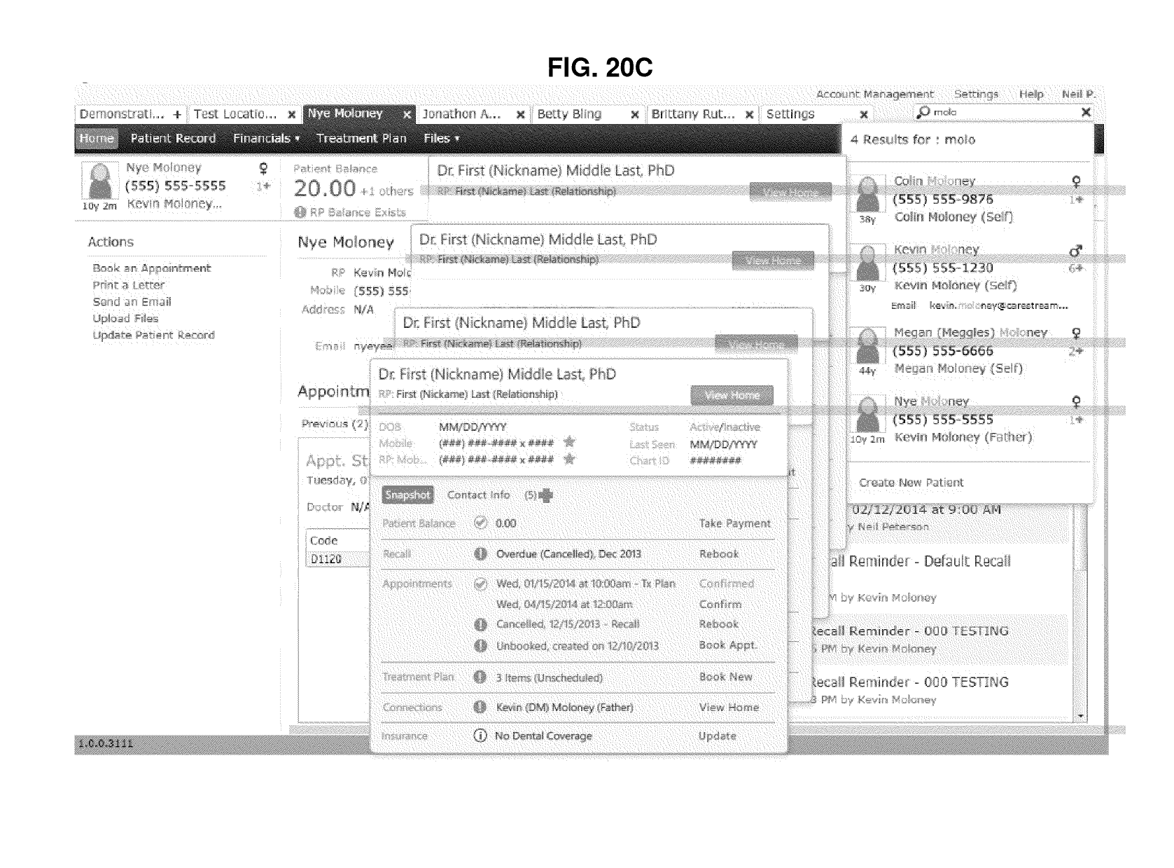

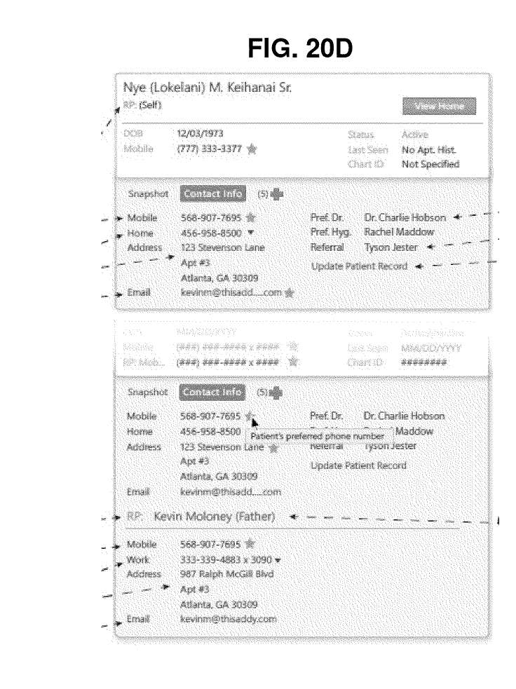

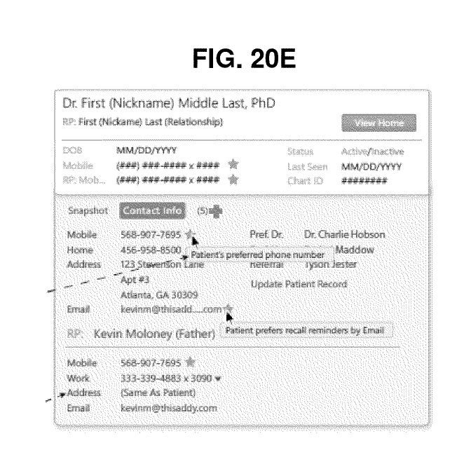

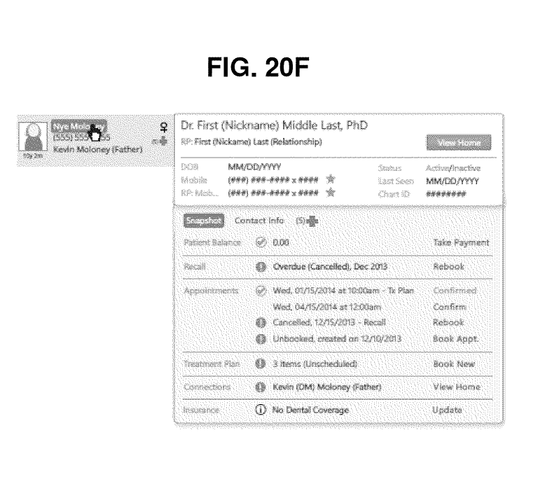

Detailed and historical information about the patient's scheduling and appointments is accessible through the patient's record, as illustrated in FIGS. 20A-20F. Multiple patient records may be open/viewed simultaneously by the user.

Insurance information is attached to the patient's record.

Icons indicate patient preferences, such as shown by the star icon in FIG. 20E, indicating a preferred phone number and method of contact.

A computer program product may include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The methods described above may be described with reference to a flowchart. Describing the methods by reference to a flowchart enables one skilled in the art to develop such programs, firmware, or hardware, including such instructions to carry out the methods on suitable computers, executing the instructions from computer-readable media. Similarly, the methods performed by the service computer programs, firmware, or hardware are also composed of computer-executable instructions.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A dental management practice method for a dental office having a plurality of treatment rooms, comprising:
displaying, on a display, a plurality of colored icons, each icon associated with one of a plurality of treatment rooms at the dental office;
associating a particular color to each of a plurality of dental professionals;
updating the color of each of the plurality of icons with the particular color associated with the dental professional responsive to the location of the dental professional in the dental office; and
displaying the plurality of icons in the updated colors.

2. The method of claim 1, further comprising sending a message to one of the plurality of dental professionals indicating a room location.

3. The method of claim 1, further comprising updating the color of the icon of the treatment room to the color white when no dental professional is located in the treatment room.

4. The method of claim 1, further comprising displaying a second icon adjacent the colored icon representative of an event affecting an appointment scheduled for the treatment rooms associated with the colored icon.

5. The method of claim 4, further comprising sending a message to one of the plurality of dental professionals indicating the room location associated with the second icon.

6. A dental management practice method, comprising:
accessing a patient record in a dental management practice system; and
updating the patient record responsive to an alert indicator associated with the patient record indicative of an event affecting an appointment scheduled for the patient.

7. The method of claim 6, further comprising:
rescheduling the patient's appointment;
sending an email or text message to the patient confirming the rescheduled appointment; and
storing a copy of the email or text sent to the patient in the patient record.

8. The method of claim 6, further comprising storing a note in the patient record indicative of the event affecting the scheduled appointment.

9. A computer storage medium having instructions stored therein for causing a computer to perform the method of claim 1.
